(19) United States
(12) Patent Application Publication
(10) Pub. No.: US 2008/0119315 A1
(43) Pub. Date: May 22, 2008

(54) TRANSMISSION

(76) Inventor: Thomas Towles Lawson, Charlottesville, VA (US)

Correspondence Address: LAUBSCHER & LAUBSCHER, P.C., 1160 SPA ROAD, SUITE 2B, ANNAPOLIS, MD, 21403, US

(21) Appl. No.: 11/942,961

(22) Filed: Nov. 20, 2007

Related U.S. Application Data
(60) Provisional application No. 60/866,993, filed on Nov. 22, 2006.

(51) Int. Cl. F16H 37/06; B60W 10/10; G06F 17/00

(52) U.S. Cl. 475/6; 192/218; 701/51

(57) ABSTRACT

A motor vehicle transmission includes a power splitter connected with the vehicle engine and two differential clutches connected with the outputs of the splitter. Separate gearboxes including alternating sequential gear mechanisms are arranged in each gearbox. The clutches are independently operated under control of an electronic control unit to provide continuous flow of power from the engine to the gearboxes which may be simultaneously operated. The clutches are driven by motors, respectively, under control of the electronic control unit.

This application claims the benefit of U.S. provisional application No. 60/866,993 filed Nov. 22, 2007.

### BACKGROUND OF THE INVENTION

The two primary types of transmissions for vehicles and are manual and automatic transmissions. In a manual transmission, a gear box contains a plurality of gears and a clutch mechanism is used to engage and disengage the gears upon manual operation of a shift lever by the operator. In an automatic transmission, planetary gears and a torque converter are used to shift the gears automatically in accordance with the speed of the vehicle and the speed of the engine used to propel the vehicle.

Traditional manual transmissions are more efficient and provide more vehicle control with reduced reliance on the brakes of a vehicle. Automatic transmissions are generally easier to operate and the torque converter acts as a non-rigid link between the engine and the drive shaft to protect the power train of the vehicle and reduce shock during shifting of the gears. A major drawback of the automatic transmission is the tendency for the torque converter to slip which reduces its efficiency.

The present invention relates to an improved transmission which combines the benefits of the manual and automatic transmissions without the need for traditional clutches and torque converters.

### BRIEF DESCRIPTION OF THE PRIOR ART

Recent advancements in both manual and automatic transmissions have incorporated computer controls and links between the engine control computer and the transmission control computer. One advancement is the automated (as opposed to automatic) manual transmission (AMT). An AMT includes the basic components of a manual transmission, the clutch and gearbox, but a computer controls actuators which physically move the gear shift forks to change gears, thereby obviating the need for a clutch pedal. Automated manual transmissions still incur a pause between shifting of the gears and the pressure plate of the clutch acts on the engine's flywheel, thus generating unwanted longitudinal thrust. However, the cost of an automated manual transmission can be 1/10 the cost of a comparable automatic transmission.

Also known in the art are transmissions having two gearboxes with interspersed gear ratios and a dual clutch mechanism. One gearbox has first, third and fifth gears driven by one clutch and the other gearbox has second, fourth, and sixth gears driven by the other clutch. A computer determines which gear to pre-select, manipulates the engine for shifting of the gears, and controls the clutches to implement the shift. The clutches engage and disengage their respective gears simultaneously so that flow of power from the engine to the drive wheels is uninterrupted. The computer can control the entire process automatically or by responding to signals from the operator. The dual clutch transmission can be disassociated from the engine flywheel in order to eliminate thrust loads on the engine crankshaft.

Computer control of automatic transmissions allows for smoother shifting and more efficient torque converters. In addition, the transmission computer can control the engine computer to temporarily reduce torque output for the duration of a shift. This momentary torque reduction reduces the slip and shock absorption of the torque converter which facilitates its operation.

Gear ratios of an automatic transmission are controlled by friction bands on planetary gear sets. In some applications, the torque converter could be eliminated. However, starting the vehicle from a stopped condition and shock loads are still a problem in such transmissions.

The present invention was developed in order to overcome these and other drawbacks of the prior transmissions by providing a dual gearbox transmission wherein differential clutches operated by separate motors are used to effect shifting of the gears in each box.

### SUMMARY OF THE INVENTION

In accordance with the invention, a transmission is connected with the engine of a vehicle and includes a power splitter connected with the engine and having two outputs. A differential clutch is connected with each of the outputs and a gear mechanism is connected with each differential clutch. Preferably, each gear mechanism includes gears of different ratios which alternate sequentially. A motor is connected with each differential clutch to provide torque to the differential clutches to control the operation thereof. A controller is connected with each motor to control the torque delivered to the differential clutches to simultaneously control shifting of gears within the gear mechanism in accordance with operator input.

A brake mechanism under control of the controller is connected between the motor and the respective differential clutch to further control the torque between the motors and the clutches. Preferably, each motor is a hydraulic motor and a storage device such as a hydraulic reservoir is connected with each motor.

A third gear mechanism is connected with one of the outputs of the power splitter to disconnect one of the differential clutches and its associated gear mechanism. A third brake mechanism is connected with the power splitter to prevent the engine from rotating under certain conditions.

### BRIEF DESCRIPTION OF THE FIGURES

Other objects and advantages of the invention will become apparent from a study of the following specification when viewed in the light of the accompanying drawing, in which:

FIG. 1 is a schematic view of a dual clutch transmission according to the prior art; and

FIG. 2 is a schematic view of a transmission according to a preferred embodiment of the invention.

### DETAILED DESCRIPTION

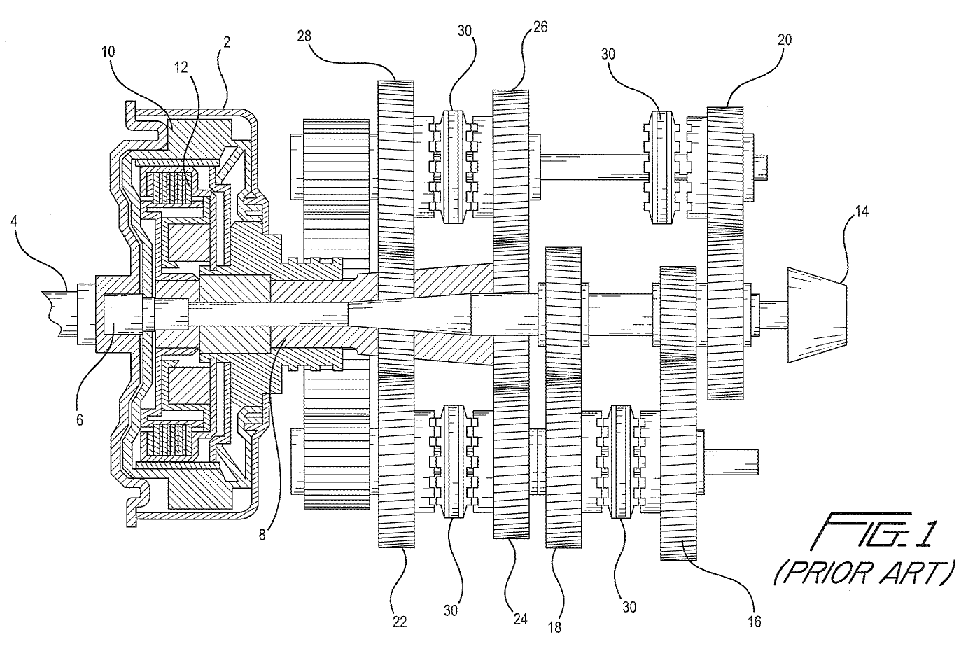

In FIG. 1 there is shown a dual-clutch or semi-automatic transmission as is known in the prior art. A clutch housing 2 contains a central dual shaft having an input end 4 connected with the engine (not shown) of a vehicle. The shaft is a dual shaft with independently rotating inner 6 and outer 8 portions. The clutch case contains a first clutch 10 and a second clutch 12. Six gear sets are connected with the shafts of the clutch case and provide a drive output 14 to a differential (not shown) of the engine. First 16, third 18, and fifth 20 gear mechanisms are connected with the inner shaft and second 22, fourth 24, sixth 26, and reverse 28 gear mechanisms are connected with the outer shaft to provide the first through fifth and reverse gears for the transmission. Gear selectors 30 are arranged adjacent to each gear mechanism. Because the clutches operate independently and the gear mechanisms alternate sequentially between the inner and outer shafts, shifting of the gears from first through sixth can overlap without interrupting the power flow from the engine for smooth transition between the gears.

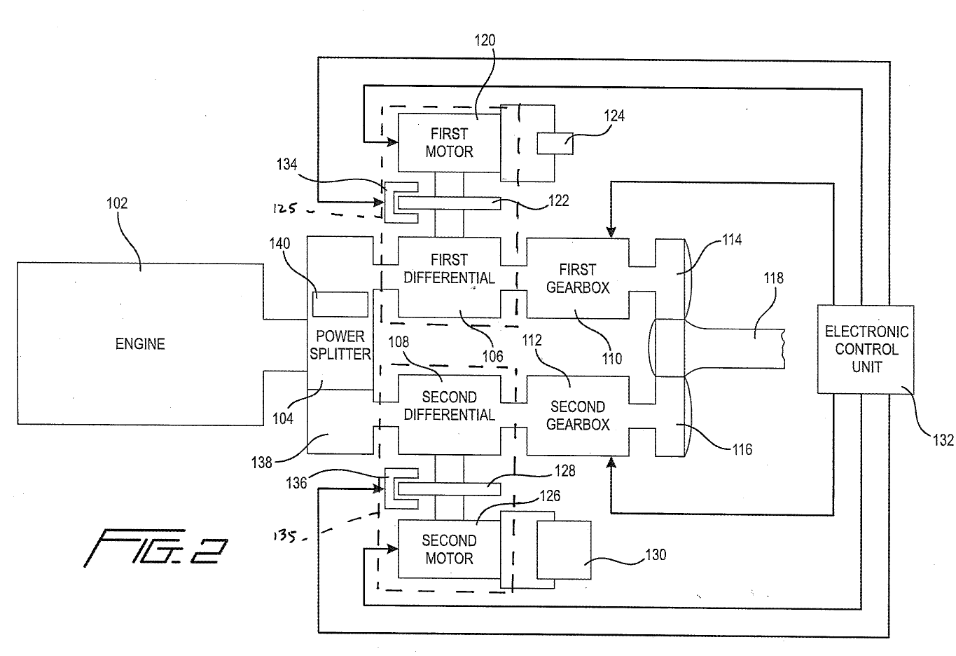

Turning now to FIG. 2, the transmission according to the present invention will be described. It relates to a dual clutch transmission but with computer controlled differential clutches for improved performance. More particularly, an engine 102 provides power flow to the transmission. A power splitter 104 is connected with the output from the engine to split the power flow in two. A first differential clutch 106 is connected with one output of the power splitter and a second differential clutch 108 is connected with the other output of the power splitter. A first gearbox 110 is connected with the first differential clutch 106 and a second gearbox 112 is connected with the second differential clutch 108. The gearboxes contain sequentially alternating gear mechanisms. For example, the first gearbox contains mechanisms for second, fourth, and reverse gears, while the second gearbox contains mechanisms for first, third, and fifth gears. Additional (or fewer) gear mechanisms may be provided, depending on the type of vehicle with which the transmission is being used. The outputs of the first and second gearboxes are connected with output gears 114 and 116, respectively, which in turn are geared to one another and connected with a drive shaft 118 of the vehicle.

Each differential clutch includes a drive mechanism to control the F operation thereof. More particularly, a first motor 120 is connected with the first differential clutch via a braking device 122. The first motor has a storage device 124 connected thereto. Similarly, a second motor 126 is connected with the second differential clutch via a braking device 128 and a storage device 130 is connected with the second motor. The first and second motors are electric or air or hydraulic motors and the storage devices may be batteries, capacitors, air tanks, or hydraulic reservoirs depending on the type of motor being used.

In order to control the operation of the transmission, an electronic control unit 132 is provided. This unit receives input from the operator of the vehicle, such as throttle control, brake application, and gear selector input and controls the operation of the clutches and gearboxes accordingly. More particularly, the electronic control unit is connected with the first and second motors 120, 126, the first and second gearboxes, 110, 112, and with brake calipers 134 and 136, respectively, of the braking devices 122, 128. In accordance with signals from the unit, the amount and direction of torque applied by the motors to the associated differentials is controlled to automatically control the shifting of the gear mechanisms in each gearbox.

A further gearbox or clutch 138 may be provided between the power splitter and one of the differential clutches. In the embodiment shown, the further gearbox is between the power splitter 104 and the second differential clutch 108. When the second gearbox 112 is in neutral, the further gearbox allows rotation to cease in the gearbox to reduce friction. In addition, a further brake mechanism 140 can also be provided to prevent the engine from rotating during certain operating cycles.

The operation of the transmission from standing to cruising speed using maximum acceleration will now be described for an electrical embodiment where the motors 120 and 126 are electric motors and the storage devices 124 and 130 are batteries. First and second gears are simultaneously engaged in gearboxes 112 and 110, respectively. The engine 102 runs at full revolutions per minute. When the service brake is released, the electronic control unit signals negative torque to be applied by the second motor 126. The first and second motors 120 and 126 are spinning because the engine is spinning, but the output shafts from the first and second differential clutches 106 and 108 are stopped because they are geared through first and second gearboxes 110 and 112, respectively to the wheels and the vehicle is stationary. The negative torque applied by the second motor 126 supplies enough load to slow the engine to its torque peak. This generates electricity to the second storage device (battery) 130. Meanwhile, the first motor 120 receives electricity from the storage device (battery) 124 and applies positive torque to its output and the first differential 106 to supplement the torque from the engine 102 while at the same time sending the same amount of negative torque to the first gearbox 110 to operate second gear.

The net effect is to increase the acceleration of the vehicle over what could be achieved by only applying the negative torque of second motor 126 because that torque reacts against the engine torque plus the torque of the first motor 120 and is driving the deeper gear ratio, namely first gear of the second gearbox 112. Depending on the torque available from the second motor 126, activation of the brake caliper 136 may be needed to counteract all of the power coming from the engine.

The vehicle accelerates unless there is wheel spin in which case less torque will be applied by one or both of the first and second motors 120, 126 and/or the throttle opening of the engine is reduced. In addition, negative torque could be applied from the first motor 120 and allow the second gearbox 112 to shift to third gear. This is analogous to a race car driver losing traction and simply going to the next gear rather than modulating the throttle.

The use of the motors 120 and 126 to provide negative torque or braking force has the same affect as engaging the clutch in a traditional manual transmission. The second motor 126 decelerates more quickly than the first motor 120 because the speed of the output shaft from the second differential clutch is higher for a given vehicle speed because of the lower ratio of first gear. The second motor 126 slows to a stop and then begins to spin in the opposite direction, now drawing from the storage device 130 and still applying torque in the same direction with the same force.

Since the second motor 126 is now drawing electricity from the storage device 130, the first motor 120 begins applying negative torque effectively engaging second gear but also generating electricity which is sent to storage device 124. When the second motor 126 approaches its speed limit, the first brake caliper 134 assists the first motor 120 to apply negative torque. This unloads the second differential clutch 108 and the second gearbox 112 so that the second gearbox can be easily shifted to third gear. If the brake caliper 134 is properly modulated, the flow of torque to the drive shaft is uninterrupted. Once third gear is engaged in the second gearbox 112, the second motor 126 begins applying positive torque to the engine 102 and subtracting it from the second gearbox 112. However, as was the case then the first and second gears were engaged, the torque is multiplied more by the lower gear, in this case the second gear in the first gearbox 110. The first motor 120 is accelerating because brake caliper 134 has been released after the gear shift. As the first motor 120 approaches its speed limit, the brake caliper 136 allows the second motor 126 to unload the first differential clutch 106 and the first gearbox 110 so that fourth gear can be selected in the first gearbox 110. The process is repeated for fourth gear until the first motor 120 is stopped and brake caliper 134 is engaged.

The overall drive ratio is determined so that at cruising speed on flat ground, the engine is at just a high enough revolutions per minute to maintain the cruise at wide open throttle. The additional clutch 138 is a conventional clutch or a simple synchronized single gear power transmitter that is either engaged or not engaged. No significant torque will be transmitted through the additional clutch during its engage or disengaged conditions because all of the torque from the engine is directed through the first differential clutch 106 and first gearbox 110 during this period. The additional clutch 138 is disengaged and the second gearbox 112 is shifted to neutral to eliminate rotation in that part of the drive train during cruising speed.

Cruise is maintained during different driving conditions such as when the vehicle is climbing a hill or into a headwind. When additional load from such conditions is placed on the vehicle, the first brake caliper 134 is released and the first motor 120 spins in order to allow the engine to increase in revolutions per minute. If not enough torque is immediately available, then third gear in the second gearbox 112 is selected and the second motor 126 increases to an appropriate speed to allow easy engagement of the further (input/output) gearbox 138. The second motor 126 now supplies torque to help accelerate the vehicle. At this point, the storage device 124 may not be experience a net loss because the second motor 126 is applying negative torque and therefore generating electricity. The situation where both motors are spinning is employed if the storage device capacity (i.e. battery charge) drops below a minimum. Many different modes can be employed to recharge the storage device. If even more power is needed, the engine revolutions per minute can rise and the second motor 126 can slow to where, if it stops, the vehicle can be said to be in third gear, or further downshifting may occur to select second gear in the first gearbox 110.

In an alternate acceleration mode, the engine 102 remains off and the first and second motors 120 and 126 spin against the engine to drive the vehicle. In order to accomplish this, the further brake mechanism 140 is operated to stop the engine, and thus the power splitter, from spinning.

The electronic control unit 132 uses the first and second motors 120, 126 to synchronize the ground speed and engine speed for a given gear ratio, thus reducing the shift effort and mechanical synchronizer wear. With proper selection and control of the motors, the need for synchronizers may be reduced or eliminated.

Although the gearboxes of the invention have been described as being connected with the drive shaft of a vehicle, alternate arrangements may be devised for different applications. For example, in a four wheel drive vehicle or piece of machinery, one gearbox can be connected with the front axle of the vehicle and the other gearbox can be connected with the rear axle of the vehicle.

While the preferred forms and embodiments of the invention have been illustrated and described, it will be apparent to those of ordinary skill in the art that various changes and modifications may be made without deviating from the inventive concepts set forth above.

1. A transmission connected with the engine of a vehicle, comprising
(a) power splitter connected with the engine and having two outputs;
(b) first and second differentials connected with said power splitter outputs, respectively;
(c) first and second gearboxes connected with said first and second differentials, respectively, and having outputs connected with a drive shaft, said first and second gearboxes including gear mechanisms of different ratios;
(d) first and second motors connected with said first and second differentials to control the operation thereof; and
(e) a controller connected with said first and second motors for controlling the torque delivered to said first and second differentials, respectively, to simultaneously control shifting of gear mechanisms within said first and second gearboxes in accordance with operator input.

2. A transmission as defined in claim 1, and further comprising a brake mechanism between said first and second motors and said first and second differentials, respectively, to further control the torque between said respective motors and clutches.

3. A transmission as defined in claim 2, wherein said controller is further connected with said brake mechanisms.

4. A transmission as defined in claim 3, and further comprising a storage device connected with each motor.

5. A transmission as defined in claim 4, wherein said storage device comprises one of a battery, capacitor, air tank, and hydraulic reservoir.

6. A transmission as defined in claim 5, wherein said controller is further connected with said first and second gearboxes.

7. A transmission as defined in claim 6, wherein each of said motors comprises one of an electric and an air and a hydraulic motor.

8. A transmission as defined in claim 1, wherein said gear mechanisms of said first and second gearboxes have alternating sequential ratios.

9. A transmission as defined in claim 8, and further comprising a third gearbox connected with one of the outputs of said power splitter, said third gearbox being operable to disconnected one of said differentials and its associated gear mechanisms.

10. A transmission as defined in claim 9, and further comprising a third brake mechanism connected with said power splitter to prevent the engine from rotating under certain conditions.
